(19) United States
(12) Patent Application Publication
(10) Pub. No.: US 2026/0358480 A1
(43) Pub. Date: Nov. 12, 2026

(54) LIGHT DETECTION DEVICE, LIGHT DETECTION METHOD, AND STORAGE MEDIUM

(71) Applicant: DENSO CORPORATION, Kariya-city (JP)

(72) Inventor: Akifumi UENO, Kariya-city (JP)

(21) Appl. No.: 19/719,867

(22) Filed: Jun. 25, 2026

Related U.S. Application Data
(63) Continuation of application No. PCT/JP2025/000795, filed on Jan. 14, 2025.

(30) Foreign Application Priority Data
Jan. 17, 2024 (JP) 2024-005514

(51) Int. Cl. G01S 7/481; G01S 7/484; G01S 17/08

(52) U.S. Cl. CPC G01S 7/4817; G01S 7/4815; G01S 7/484; G01S 17/08

(57) ABSTRACT

A controller of a light detection device acquires an actual angle of an oscillating mirror at start and end timings of a previous outward period, during which an irradiation beam is scanned. The controller corrects a start angle and an end angle of a current outward period in response to an angle deviation between a control command angle and a previous actual angle. The controller controls an angular velocity of the oscillating mirror by variably setting a control command angle between the start angle and the end angle for each control timing. The controller sets a light emission timing of a light source for each set change amount of the actual angle in the current outward period.

### CROSS REFERENCE TO RELATED APPLICATIONS

The present application is a continuation application of International Patent Application No. PCT/JP2025/000795 filed on Jan. 14, 2025, which designated the U.S. and claims the benefit of priority from Japanese Patent Application No. 2024-005514 filed on Jan. 17, 2024. The entire disclosures of all of the above applications are incorporated herein by reference.

### TECHNICAL FIELD

The present disclosure relates to a light detection device, a light detection method, and a storage medium storing a light detection program.

### BACKGROUND

An oscillator device deflects a light beam. The oscillator device executes a control loop to control an amplitude control value based on a difference between a target oscillation amplitude and a detected oscillation amplitude.

### SUMMARY

According to an aspect of the present disclosure, a light detection device includes: an irradiation unit to generate and irradiate an irradiation beam by emitting light from a light source; a scanning unit including an oscillating mirror to oscillate to scan the irradiation beam; a light receiving unit to receive a reflected beam; and a controller including at least one of (i) a circuit and (ii) a processor with a memory to output control commands of a light emission timing of the light source and a control command angle of the oscillating mirror. The controller may acquire an actual angle of the oscillating mirror in a previous outward period with respect to start and end timings of an outward period during which the irradiation beam is scanned, of an oscillation period of the oscillating mirror. The controller may correct a start point command angle and an end point command angle, each of which being the control command angle of the oscillating mirror at a start timing and an end timing in a current outward period, in response to an angle deviation between the control command angle and the actual angle at a start timing and an end timing in the previous outward period. The controller may control the angular velocity of the oscillating mirror by variably setting the control command angle between the start point command angle and the end point command angle for each control timing between the start timing and the end timing in the current outward period. The controller may set a light emission timing of the light source for each set change amount of the actual angle in the current outward period.

### BRIEF DESCRIPTION OF DRAWINGS

FIG. 1 is a schematic diagram showing a light detection device according to a first embodiment.

FIG. 2 is a schematic diagram showing a mechanical configuration of an irradiation unit of the first embodiment.

FIG. 3 is a schematic diagram showing a mechanical configuration of a light receiving unit of the first embodiment.

FIG. 4 is a block diagram showing a control unit of the first embodiment.

FIG. 5 is a block diagram equivalently showing control contents of an amplitude control block.

FIG. 6 is a graph showing an example of a control waveform.

FIG. 7 is a graph showing a relationship between an oscillation period and control period.

FIG. 8 is a flowchart showing a part of a light detection flow.

FIG. 9 is a flowchart showing a part of a light detection flow.

FIG. 10 is a flowchart showing a part of a light detection flow.

FIG. 11 is a flowchart showing a part of a light detection flow according to a second embodiment.

FIG. 12 is a graph showing an example of a control waveform of the second embodiment.

FIG. 13 is a flowchart showing a part of a light detection flow according to a third embodiment.

FIG. 14 is a graph showing an example of a control waveform of the third embodiment.

FIG. 15 is a flowchart showing a part of a light detection flow according to a fourth embodiment.

FIG. 16 is a flowchart showing a part of a light detection flow according to a fourth embodiment.

FIG. 17 is a graph showing an example of a control waveform of the fourth embodiment.

### DESCRIPTION OF EMBODIMENTS

An oscillator device deflects a light beam. The oscillator device executes a control loop to control an amplitude control value based on a difference between a target oscillation amplitude and a detected oscillation amplitude. The oscillator device sets a gain of the control loop based on the amplitude control value in a state where the oscillation amplitude of the oscillator becomes the target oscillation amplitude.

If one of the maximum amplitude value and the minimum amplitude value satisfies the target oscillation amplitude and the other does not, it may be difficult to correct only the other to the target oscillation amplitude. Since the oscillation amplitude is set by changing the gain of the control loop, if the gain is changed to correct the other to the target oscillation amplitude, the one of the maximum amplitude value and the minimum amplitude value will also be changed. In this case, the one of the maximum amplitude value and the minimum amplitude value may deviate from the target oscillation amplitude. If a deviation in the scanning direction becomes large, the scanning accuracy will be lowered.

The present disclosure provides a light detection device and a light detection method to improve scanning accuracy. The present disclosure provides a storage medium storing a light detection program to improve scanning accuracy.

According to a first aspect of the present disclosure, a light detection device configured to detect a reflected beam reflected corresponding to an irradiation beam includes: an irradiation unit to generate and irradiate the irradiation beam by emitting light from a light source; a scanning unit including an oscillating mirror to oscillate back and forth to scan the irradiation beam; a light receiving unit to receive the reflected beam; and a controller to output control commands of a light emission timing of the light source in the irradiation unit and an angle of the oscillating mirror in the scanning unit. The controller acquires an actual angle of the oscillating mirror in a previous outward period with respect to start and end timings of an outward period in which the irradiation beam is scanned, of an oscillation period of the oscillating mirror. The controller corrects a start point command angle and an end point command angle, which are respectively control command angles of the oscillating mirror at a start point timing and an end point timing in a current outward period, in response to an angle deviation between the control command angle and the actual angle at the start point timing and the end point timing in the previous outward period. The controller controls the angular velocity of oscillation by variably setting a control command angle between the start point command angle and the end point command angle for each control timing obtained by division between the start point timing and the end point timing in the current outward period. The controller sets a light emission timing of the light source for each set change amount of the actual angle in the current outward period.

According to a second aspect of the present disclosure, a light detection method is executed by a processor to control a light detection device, which detects a reflected beam reflected corresponding to an irradiation beam to be scanned by an oscillating mirror. The light detection method includes: acquiring an actual angle of the oscillating mirror in a previous outward period with respect to start and end timings of an outward period in which the irradiation beam is scanned, of the oscillation period of the oscillating mirror. The light detection method includes: correcting a start point command angle and an end point command angle, which are control command angles of the oscillating mirror at the start point timing and the end point timing in the current outward period, in accordance with an angle deviation between the control command angle and the actual angle at the start point timing and the end point timing in the previous outward period. The light detection method includes: controlling the angular velocity of oscillation by variably setting a control command angle between the start point command angle and the end point command angle in the current outward period, for each control timing obtained by division between the start point timing and the end point timing. The light detection method includes: setting a light emission timing of a light source that generates the irradiation beam for each set change amount of the actual angle in the current outward period.

According to a third aspect of the present disclosure, a light detection program is stored in a storage medium and includes instructions to be executed by a processor to control a light detection device that detects a reflected beam reflected corresponding to an irradiation beam to be scanned by an oscillating mirror. The instructions of the program, when executed by the processor, causes the processor to implement: acquiring an actual angle of the oscillating mirror in the previous outward period with respect to the start and end timings of the outward period in which the irradiation beam is scanned, of the oscillation period of the oscillating mirror; correcting a start point command angle and an end point command angle, which are control command angles of the oscillating mirror at the start point timing and the end point timing in the current outward period, in accordance with an angle deviation between the control command angle and the actual angle at the start point timing and the end point timing in the previous outward period; controlling the angular velocity of oscillation by variably setting a control command angle between the start point command angle and the end point command angle in the current outward period for each control timing obtained by division between the start point timing and the end point timing; and setting a light emission timing of a light source that generates the irradiation beam for each set change amount of the actual angle in the current outward period.

According to the first to third aspects, each of the start point command angle and the end point command angle is corrected in accordance with the angle deviation, and the angular velocity is controlled between the corrected start point command angle and the corrected end point command angle. Therefore, the deviation of the actual angle at the start point timing and the end point timing is reduced compared with a case where the control gain is set uniformly depending on the angle amplitude. The light emission timing is set for each set change amount of the actual angle whose angular velocity is controlled between the corrected start point command angle and the corrected end point command angle. Therefore, a decrease in scanning accuracy due to deviation in the scanning direction can be reduced.

Hereinafter, several embodiments of the present disclosure will be described with reference to the drawings. In the following, corresponding components in each embodiment are denoted by the same reference numerals, and redundant descriptions may be omitted. Furthermore, in cases where only a part of the configuration is described in each embodiment, the configurations of other parts previously described in other embodiments may be applied to those parts. Furthermore, in addition to the combinations of configurations explicitly described in each embodiment, it is also possible to partially combine configurations from multiple embodiments even if such combinations are not explicitly mentioned, provided that there is no hindrance to the combination.

### First Embodiment

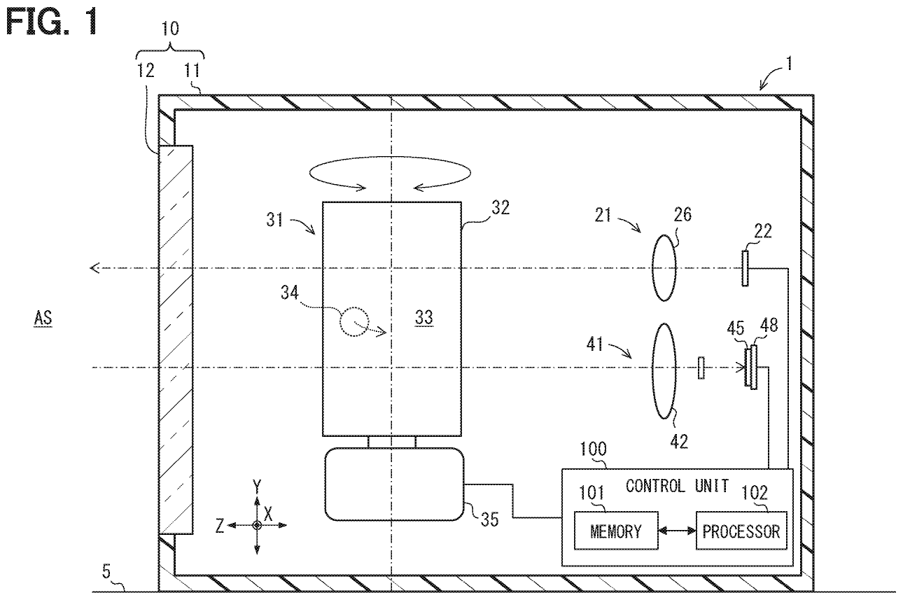

A light detection device 1 of the first embodiment shown in FIG. 1 detects a reflected beam, which is an irradiation beam reflected by a target object. The light detection device 1 is a so-called LiDAR (Light Detection and Ranging/Laser Imaging Detection and Ranging) device that can detect a distance to the target object by detecting the reflected beam.

The light detection device 1 is mounted on a vehicle 5. The vehicle 5 is a mobile body such as an automobile that can travel on a traveling path while an occupant is on the vehicle 5. The vehicle 5 is capable of executing a constant or temporary automated traveling in an automated driving control mode. Here, the automated driving control mode may be achieved with an autonomous operation control, such as conditional driving automation, advanced driving automation, or full driving automation, where the system in operation performs all driving tasks. The automated driving control mode may be achieved with an advanced driving assistance control, such as driving assistance or partial driving automation, where the occupant performs some or all driving tasks. The automated driving control mode may be implemented by any one of autonomous driving control or advanced driving assistance control, by a combination thereof, or by switching between them. The vehicle 5 is also called an autonomous vehicle or an autonomous robot.

In the following description, unless otherwise specified, each of the front, the rear, the top, the bottom, the left, and the right is defined with respect to the vehicle 5 on a horizontal plane. The horizontal direction refers to a direction parallel to a horizontal plane that serves as the directional reference for the vehicle 5. Furthermore, a vertical direction refers to a direction perpendicular to a horizontal plane serving as a direction reference for the vehicle 5.

The light detection device 1 acquires image data that can be used for driving control of the vehicle 5, including automatic control driving modes. The light detection device 1 is disposed at least one location in the vehicle 5, for example, among a front portion, a side portion on the left or right, a rear portion, an upper roof, and the like.

In the light detection device 1, a three-dimensional orthogonal coordinate system is defined by three mutually orthogonal axes: an X axis, a Y axis, and a Z axis. In this embodiment, the X axis and Z axis are set along different horizontal directions of the vehicle 5, and the Y axis is set along the vertical direction of the vehicle 5. In FIG. 1, the left side of the single chain line along the Y axis (adjacent to light-transmitting panel 12) actually shows a cross-section perpendicular to the right side of the single chain line (adjacent to module 21, 41) in the three-dimensional orthogonal coordinate system.

The light detection device 1 emits light toward a sensing area AS in the external space of the vehicle 5 according to the installation location and viewing angle. The light detection device 1 receives reflected light that is incident when the irradiated light is reflected from the sensing area AS. In response to receiving the reflected light, the light detection device 1 senses a target object that reflected the irradiated light within the sensing area AS. The sensing means measuring at least the distance from the light detection device 1 to the reflection point of the target object and the intensity of the reflection from the target object.

A typical sensing target object in the light detection device 1 applied to the vehicle 5 may be at least one type of moving object such as a pedestrian, a cyclist, a non-human animal, or another vehicle. A typical sensing target object in the light detection device 1 applied to the vehicle 5 may be at least one of stationary objects such as a guardrail, a road sign, a roadside structure, and an object fallen on the road.

The light detection device 1 includes a casing module 10, a projecting module 21, a scanning unit 31, a light receiving module 41, and a control unit 100. The casing module 10 has a housing 11 and a light-transmitting panel 12. The housing 11 is formed in a hollow box shape and is mainly made of a light-shielding member such as metal or synthetic resin. The housing 11 accommodates the projecting module 21, the scanning unit 31, and the light receiving module 41. The housing 11 holds the light-transmitting panel 12 having a plate shape made of a light-transmitting material such as glass or synthetic resin.

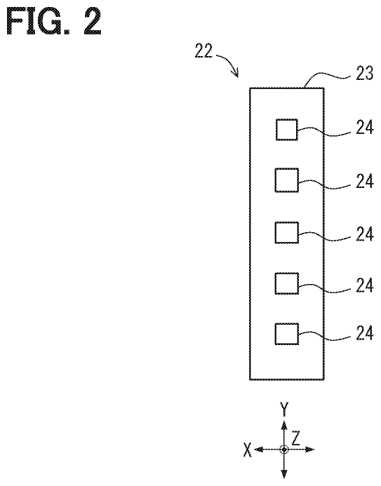

The projecting module 21 includes an irradiation unit 22 and a light projecting lens system 26. As shown in FIG. 2, the irradiation unit 22 includes light emitting diodes 24 as a light source in an array on a substrate 23. Each of the light emitting diodes 24 generates pulsed infrared laser light that serves as an irradiation beam for the sensing area AS under the control of the control unit 100. The light emitting diode 24 is provided as a laser diode, such as an edge emitter laser or a vertical cavity surface emitting laser (VCSEL).

As shown in FIG. 1, the projecting lens system 26 projects the irradiation beam generated by the light emitted from the irradiation unit 22 onto the oscillating mirror 32 of the scanning unit 31. The projecting lens system 26 demonstrates at least one type of optical function among, for example, condensing, collimating, shaping, and the like. The projecting lens system 26 has a projection optical axis along the Z axis. The projecting lens system 26 has at least one projecting lens on the projection optical axis, the lens shape of which corresponds to the optical effect to be exhibited. The irradiation unit 22 is positioned on the projection optical axis of the projecting lens system 26. In the irradiation unit 22, the irradiation beams emitted by the light emitting diodes 24 are guided along the projection optical axis of the projecting lens system 26.

The scanning unit 31 includes an oscillating mirror 32, a biasing member 34, and a scanning motor 35. The oscillating mirror 32 is formed in a plate shape by vapor-depositing a reflective film on a reflective surface 33 of a base material. The oscillating mirror 32 is supported by the housing 11 to be rotatable around a rotation center line along the Y axis. The oscillating mirror 32 oscillates back and forth within a driving range that is limited by the function of a mechanical or electrical stopper.

The oscillating mirror 32 is provided in common to the projecting module 21 and the light receiving module 41. The oscillating mirror 32 irradiates the incident illumination beam from the projecting lens system 26 of the projecting module 21 onto the sensing area AS through the light-transmitting panel 12 by reflecting it off the reflective surface 33, which is oriented according to the rotation angle, thereby scanning the sensing area AS both temporally and spatially. In the light detection device 1, the mechanical scanning of the sensing area AS by the irradiation beam is substantially limited to scanning in the horizontal direction.

Simultaneously with such scanning, the oscillating mirror 32 further reflects the reflected light incident from the sensing area AS through the light-transmitting panel 12 toward the light receiving module 41 by the reflective surface 33 oriented according to the rotation angle. Here, the speed of the irradiating beam and the reflected light is sufficiently large compared to the rotational speed of the oscillating mirror 32. As a result, the reflected light of the irradiation beam is guided toward the light receiving module 41 to travel in the opposite direction to the irradiation beam by the oscillating mirror 32 which rotates at approximately the same angle as the irradiation beam.

The biasing member 34 is made of an elastic body such as a spring. The biasing member 34 has one end fixed directly or indirectly to the oscillating mirror 32 and the other end fixed directly or indirectly to the housing 11. The biasing member 34 is provided to bias the oscillating mirror 32 in a specific rotation direction. When the irradiation beam is irradiated, the rotation direction of the oscillating mirror 32 is defined as the outward direction, and a return direction is opposite to the outward direction. The oscillating mirror 32 is biased by the biasing member 34 to move the oscillating mirror 32 in the return direction.

The scanning motor 35 is, for example, a voice coil motor, a direct current motor with brushes, a stepping motor, or the like. The scanning motor 35 drives the oscillating mirror 32 to rotate (i.e., oscillate) within the above-mentioned finite driving range under the control of the control unit 100. The scanning motor 35 rotates the oscillating mirror 32 in the outward direction against the biasing force of the biasing member 34. At this time, the rotation angle of the oscillating mirror 32 is changed sequentially in synchronization with the light emission cycle of the irradiation unit 22 of the projecting module 21. On the other hand, in the return direction, the scanning motor 35 rotates the oscillating mirror 32 in response to the biasing force of the biasing member 34. In this way, the scanning motor 35 causes the oscillating mirror 32 to oscillate back and forth.

The light receiving module 41 is arranged offset in the Y axis relative to the projecting module 21. The light receiving module 41 includes a light receiving lens system 42 and a light receiving unit 45. The light receiving lens system 42 exerts an optical effect to form an image of the light reflected from the sensing area AS on the light receiving unit 45. The light receiving lens system 42 forms a light receiving optical axis along the Z axis. The light receiving lens system 42 has at least one light receiving lens on the light receiving optical axis, which has a lens shape depending on the optical effect to be exerted. The reflected light incident on the reflective surface 33 of the oscillating mirror 32 is guided along the light receiving optical axis of the light receiving lens system 42 regardless of the rotation angle of the oscillating mirror 32 within the driving section.

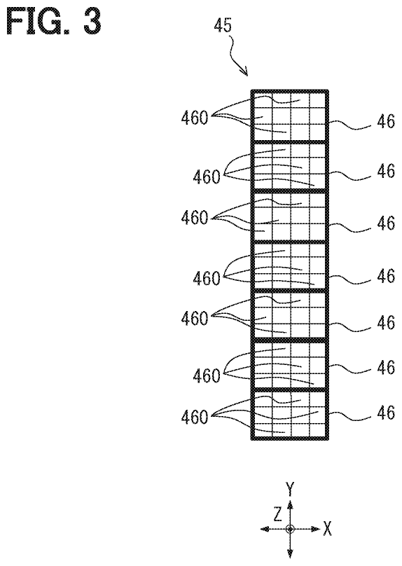

The light receiving unit 45 is positioned on the light receiving optical axis of the light receiving lens system 42. As shown in FIG. 3, the light receiving unit 45 includes light receiving pixels 46 in an array on the substrate. Each of the light receiving pixels 46 includes plural light receiving elements 460. The light receiving element 460 of the light receiving pixel 46 is formed mainly of a photodiode such as a single photon avalanche diode (SPAD). Each of the light receiving pixels 46 receives reflected light incident from the light receiving lens system 42 at each of the light receiving elements 460.

As shown in FIG. 1, the light receiving unit 45 has an output circuit 48 integrated therein. The output circuit 48 performs sampling processing under the control of the control unit 100 for each scanning line associated with the rotation angle of the oscillating mirror 32 according to the light emission period. Therefore, the output circuit 48 generates light receiving data for each scanning line based on the output signals from the light receiving pixels 46 of the light receiving unit 45 through sampling processing. The light reception data thus generated is output from the output circuit 48 to the control unit 100.

The control unit 100 is connected to the light emitting diode 24, the scanning motor 35, and the light receiving unit 45 via at least one of, for example, a LAN (Local Area Network) line, a wire harness, an internal bus, and the like. For example, the control unit 100 is housed inside the housing 11 as shown in FIG. 1. The control unit 100 includes at least one dedicated computer.

The dedicated computer of the control unit 100 may be a light detection control ECU (Electronic Control Unit) specialized for controlling the light detection device 1. The dedicated computer of the control unit 100 may be a sensor ECU that comprehensively controls plural types of on-board sensors including the light detection device 1.

The dedicated computer of the control unit 100 includes at least one memory 101 and at least one processor 102. The memory 101 is at least one type of non-transitory tangible storage medium, which non-transitorily stores computer-readable programs and data. Examples of the non-transitory tangible storage medium include semiconductor medium, magnetic medium, and optical medium. Here, “storage” may refer to accumulation in which data is retained even when the vehicle 5 is powered off, or it may refer to temporary storage in which data is erased when the vehicle 5 is powered off. The processor 102 includes at least one type of core, such as a CPU (Central Processing Unit), GPU (Graphics Processing Unit), RISC-CPU (Reduced Instruction Set Computer CPU), CISC-CPU (Complex Instruction Set Computer CPU), DFP (Data Flow Processor), or GSP (Graph Streaming Processor).

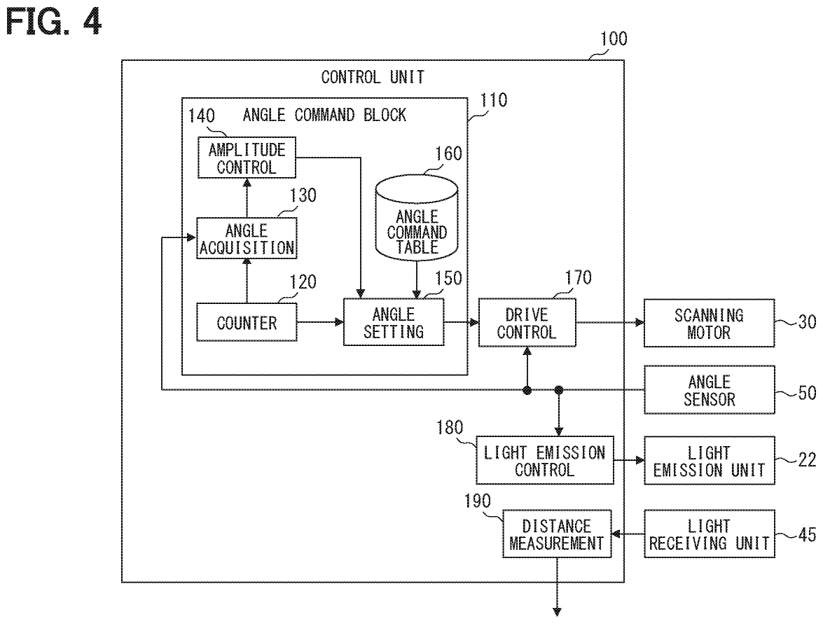

In the control unit 100, the processor 102 executes instructions in a light detection program stored in the memory 101 serving as a storage medium, to control the irradiation unit and the scanning unit. As a result, the control unit 100 constructs functional blocks for controlling the irradiation unit and the scanning unit. The functional blocks include, as shown in FIG. 4, an angle command block 110, a drive control block 170, a light emission control block 180, and a distance measurement block 190.

The angle command block 110 generates a control command angle as an angle command value for controlling the oscillating angle of the oscillating mirror 32. The angle command block 110 includes a counter block 120, an angle acquisition block 130, an amplitude control block 140, and an angle setting block 150 as sub-function blocks.

The counter block 120 functions as a counter that counts with a period of the oscillation waveform (oscillation period). The counter block 120 is reset at each oscillation period. The counter block 120 outputs a count value and a reset timing for each oscillation period.

The angle acquisition block 130 sequentially acquires the angle detection value of the oscillating mirror 32 output from the angle sensor 50 that detects the angle of the oscillating mirror 32 as the actual angle of the oscillating mirror 32. The angle acquisition block 130 acquires the actual angle at the start timing t0 and the end timing t1 of the outward period during which the irradiation beam scans, within the oscillation cycle of the oscillating mirror 32. For example, the angle acquisition block 130 sequentially stores the minimum angle value of the detected angle values output from the angle sensor 50 as the actual angle at the start timing t0 and the maximum angle value as the actual angle at the end timing t1. When the angle acquisition block 130 acquires the reset timing from the counter block 120, it initializes the maximum angle value and the minimum angle value that it has held. The actual angle of the oscillating mirror 32 at the start timing t0 may be referred to as the actual start angle, and the actual angle of the oscillating mirror 32 at the end timing t1 may be referred to as the actual end angle.

The amplitude control block 140 controls the values of the start point command angle and the end point command angle in the outward period next to the outward period in which the start point actual angle and the end point actual angle were acquired. Here, from the perspective of the “next outward period” as the center, the “next outward period” can also be written as the “current outward period.” In this case, the outward period in which the actual start angle and the actual end angle are acquired can also be referred to as the “previous outward period.” The amplitude control block 140 obtains the start point command angle for the current outward period by correcting the start point command angle of the previous outward period according to the angle deviation from the start point actual angle of the previous outward period. Similarly, the amplitude control block 140 obtains the end point command angle for the current outward period by correcting the end point command angle of the previous outward period according to the angle deviation from the end point actual angle of the previous outward period. In the following description, the “previous outward period” may be simply referred to as the “previous period,” and the “current outward period” may be simply referred to as the “current period.”

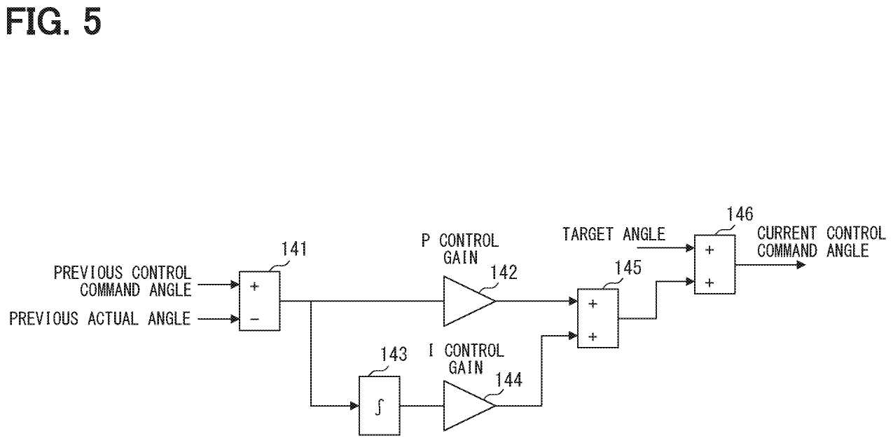

For example, the amplitude control block 140 provides feedback control, as shown in FIG. 5, by outputting a current control command angle according to feedback of the previous angle deviation. As shown in FIG. 5, the control performed by the amplitude control block 140 is equivalent to PI control using a subtractor 141, multipliers 142 and 144, an integrator 143, and adders 145 and 146.

When acquiring the start point command angle, the subtractor 141 calculates an angle deviation (start point angle deviation) which is a difference between the previous start point command angle a0+AL_1 and the previous minimum angle value. The multiplier 142 multiplies the angle deviation by a P control gain to obtain a proportional term for PI control. The integrator 143 integrates the angular deviation and outputs the result to the multiplier 144. Then, the multiplier 144 multiplies the integrated angle deviation by the I control gain to obtain an integral term for PI control. The integrator 143 uses a value stored in advance in the memory 101 or the like at the time of shipping from the factory as the initial value of the I control gain. The adder 145 adds the proportional term and the integral term together to obtain a correction amount according to the angle deviation. The adder 146 adds the correction amount AL_2 to the start point target angle a0, which is preset as the target angle to which the actual angle at the start point timing t0 converges, to obtain the corrected current start point command angle a0+AL_2.

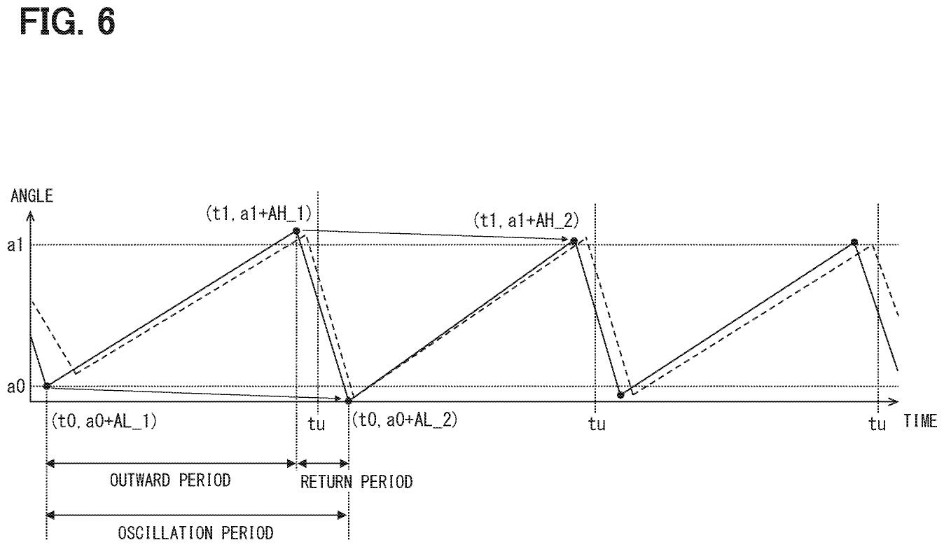

The amplitude control block 140 functions in the same way when acquiring an end point command angle. When acquiring the end point command angle, the amplitude control block 140 functions in the above description with the “start point” replaced with the “end point”. That is, the amplitude control block 140 obtains a correction amount AH_2 corresponding to the end point angle deviation between the previous end point command angle a1+AH_1 and the previous maximum angle value, and obtains the current end point command angle a1+AH_2 by adding the correction amount AH_2 to the end point target angle a1. The amplitude control block 140 obtains the start point command angle and end point command angle for each oscillating period. For example, as shown in FIG. 6, the amplitude control block 140 acquires the start point command angle and the end point command angle for the immediately following outward period at the amplitude update timing tu set in the return period. In FIG. 6 and the like, the solid line indicates the control command angle, and the broken line indicates the detected angle value.

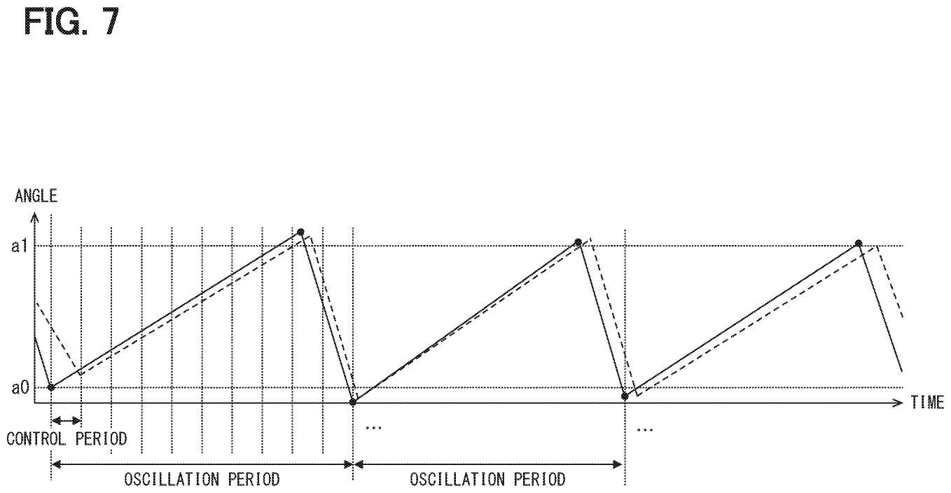

The angle setting block 150 variably sets a control command angle for each control timing obtained by dividing the period between the start timing t0 and the end timing t1 in the outward period. The control timing is defined by a control period that is shorter than the oscillation period and that corresponds to the counter value (see FIG. 7). The angle setting block 150 sets a control command angle for each control timing in accordance with the angle command table 160, the counter value, the start point command angle, and the end point command angle. Here, the angle command table 160 is data indicating the initial value of each control command angle for each control timing from the start timing t0 to the end timing t1. For example, the initial value of the control command angle is set as a value that increases linearly from the start point target angle to the end point target angle.

The angle setting block 150 sets an actual control command angle by correcting the initial value of the control command angle in the angle command table 160 corresponding to the counter value for each control timing. Specifically, the angle setting block 150 sets the actual control command angle at each control timing by linear interpolation between the current start point command angle and end point command angle. By varying the control command angle at each control timing, the angular velocity of the oscillation of the oscillating mirror 32 is successively controlled.

The drive control block 170 outputs a voltage command value for driving the oscillating mirror 32. For example, the drive control block 170 compares the control command angle with the angle detection value, and outputs a voltage command value according to feedback control that applies a gain to the difference. In the case of feedback control, the drive control block 170 may perform angular velocity control or current control at different cycles as an inner loop inside the angle control. The drive control block 170 may output a voltage command value according to open-loop control that uses a control command angle without using the angle detection value.

The drive control block 170 generates a voltage signal corresponding to the voltage command value as a drive signal for driving the scanning motor 35. The drive control block 170 outputs the generated drive signal as a control command to the scanning motor 35 to drive the scanning motor 35 to rotate.

The light emission control block 180 controls the light emission timing of the irradiation unit 22. The light emission control block 180 acquires the angle detection value and outputs a drive signal to the irradiation unit 22 for each set amount of change in the angle detection value in the outward period. The set change amount is set in advance as an angle change amount, for example, based on the upper limit number of times of light emission per pixel according to the angular velocity.

The distance measurement block 190 acquires the light reception data for each scanning line output from the output circuit 48 of the light receiving unit 45. The distance measurement block 190 senses at least the reflection point distance from the light detection device 1 to the target object, and generates distance measurement information based on the light reception data. The distance measurement block 190 outputs the generated distance measurement information to the outside of the light detection device 1. The distance measurement information may be output to, for example, an integrated ECU that integrates the driving control of the vehicle 5. The distance measurement information may be output to a recognition ECU that recognizes the outside world when controlling the driving of the vehicle 5. The distance measurement information may be output to a sensing ECU that processes sensing information from on-board sensors including the light detection device 1.

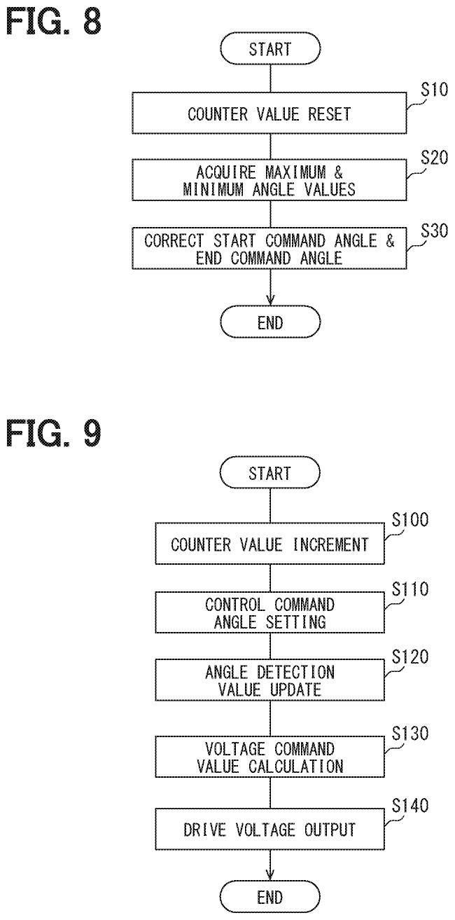

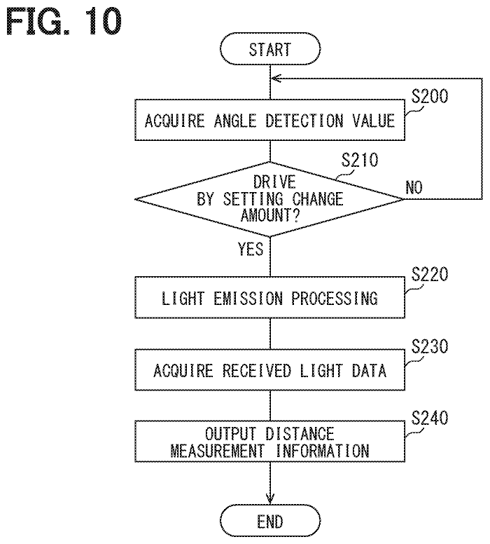

The light detection method in which the control unit 100 controls the scanning unit and the irradiation unit 22 through cooperation of the blocks 110, 170, 180, and 190 is executed according to the light detection flow shown in FIGS. 8 to 10. The light detection flow includes an amplitude correction flow shown in FIG. 8 that is executed for each oscillating period, an angular velocity control flow shown in FIG. 9 that is executed for each control period, and a distance measurement flow shown in FIG. 10 that is executed for each distance measurement period. This light detection flow is repeatedly executed while the light detection device 1 is running. Each “S” in this light detection flow represents steps executed by instructions included in the light detection program.

In the amplitude correction flow shown in FIG. 8, first, in S10, the counter block 120 resets the counter value up to the immediately preceding oscillation period. Next, in S20, the angle acquisition block 130 acquires the maximum angle value and the minimum angle value in the outward period as the actual angle of the oscillating mirror 32 at the start timing t0 and the end timing t1. Then, in S30, the amplitude control block 140 corrects the start point command angle in the next outward period in accordance with the previous start point angle deviation, and corrects the end point command angle in accordance with the previous end point angle deviation.

Next, as shown in the angular velocity control flow of FIG. 9, in each control cycle, first, in S100, the counter block 120 increments the counter value. Next, in S110, the angle setting block 150 obtains a control command angle according to linear interpolation of the start point command angle and the end point command angle corrected in the previous oscillation period. Then, in S120, the drive control block 170 acquires the current angle detection value from the angle sensor 50. Next, in S130, the drive control block 170 obtains a voltage command value corresponding to the obtained angle detection value. Then, in S140, the drive control block 170 outputs a drive voltage corresponding to the voltage command value to the scanning motor 35.

Next, the distance measurement flow executed in each distance measurement cycle will be described below with reference to FIG. 10. First, in S200, the light emission control block 180 acquires the angle detection value. Next, in S210, the light emission control block 180 determines whether or not the oscillating mirror 32 has been rotated by the set change amount based on the angle detection value.

When it is determined that the rotational drive has not been performed by the set amount of change, the processor returns to S200. When it is determined that the rotation has been driven by the set amount of change, the processor proceeds to S220. In S220, the light emission control block 180 outputs a drive signal to the irradiation unit 22, causing the irradiation unit 22 to emit light. By the processing of S200, S210, and S220, the light emission timing is controlled in accordance with the change in angle of the oscillating mirror 32.

In S230 following S220, the distance measurement block 190 acquires light reception data from the output circuit 48 of the light receiving unit 45. Then, in S240, the distance measurement block 190 outputs distance measurement information based on the light reception data.

According to the first embodiment, the start point command angle and the end point command angle in the current outward period are corrected in accordance with the angle deviation in the previous outward period. Then, the angular velocity of oscillation is controlled by variably setting the control command angle between the start point command angle and the end point command angle for each control timing. Furthermore, the timing of light emission of the light emitting diode 24 is set for each set amount of change in the actual angle. Therefore, the start point command angle and the end point command angle are individually corrected in accordance with the angle deviation, and the angular velocity is controlled between the corrected start point command angle and the corrected end point command angle. Therefore, the deviation of the actual angle at the start timing t0 and the end timing t1 can be reduced compared with a case where the control gain is set uniformly depending on the angle amplitude. The light emission timing is set for each set change amount of the actual angle whose angular velocity is controlled between the corrected start point command angle and end point command angle, so that a decrease in scanning accuracy due to deviation in the scanning direction can be restricted.

According to the first embodiment, the angular velocity is linearly controlled. Therefore, fluctuations in angular velocity in linear control can be restricted.

According to the first embodiment, the oscillating mirror 32 is biased in the return path. Therefore, it is possible to improve the scanning accuracy in the light detection device 1, while the angle control during scanning in the outward direction is likely to fluctuate significantly due to assembly errors of the oscillating mirror 32, which is biased in the opposite direction when emitting light in the outward period.

### Second Embodiment

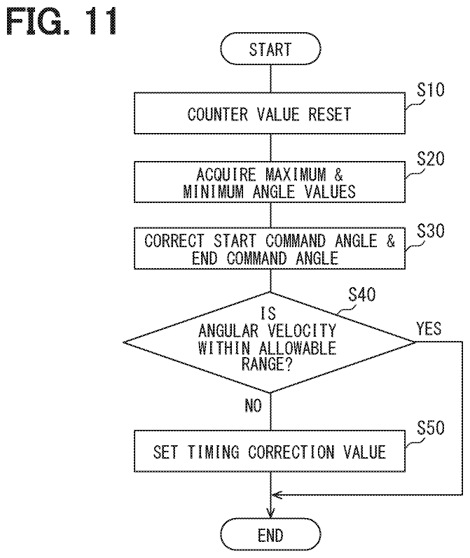

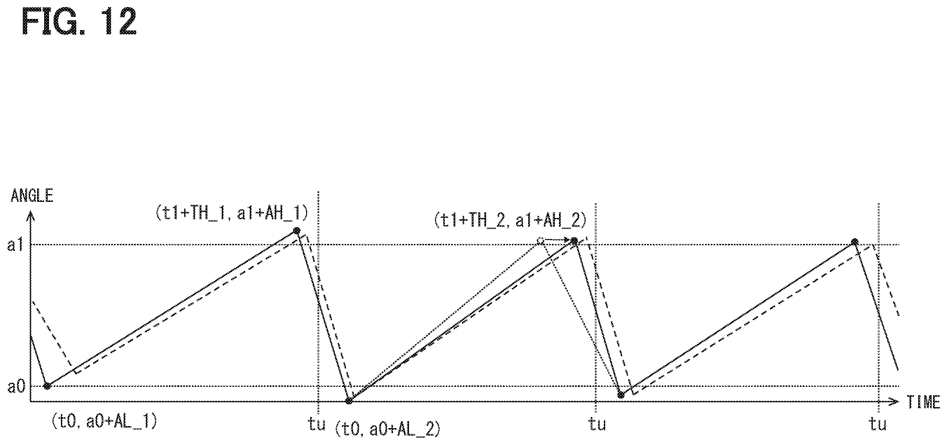

As shown in FIGS. 11 and 12, the second embodiment is a modification of the first embodiment.

In the second embodiment, in the amplitude correction flow, the processor proceeds to S40 after S30 as shown in FIG. 11. In S40, the amplitude control block 140 determines whether or not the angular velocity condition for correcting the end timing t1 is met. The angular velocity condition is met when adjustment of the angular velocity in the previous outward period is necessary. For example, the angular velocity condition is met when the angular velocity is out of the allowable angular velocity range. Here, in the allowable angular velocity range, the angular velocity is less than or equal to an upper threshold value and greater than or equal to a lower threshold value. The angular velocity condition may be determined depending on whether or not the angular velocity estimated from the change over time of the detected angle value falls within the allowable velocity range. The angular velocity condition may be determined based on whether the instantaneous current value flowing through the scanning motor 35 in the return period rises to a value out of the allowable current value range. An increase in the instantaneous current value in the return period to a value out of the allowable current value range corresponds to an excessive increase in the angular velocity in the return period, that is, a decrease in the angular velocity in the outward period to a value out of the allowable angular velocity range.

When it is determined that the angular velocity is within the allowable angular velocity range, this amplitude correction flow skips S50. When it is determined that the angular velocity is outside the allowable angular velocity range, the amplitude correction flow proceeds to S50. In S50, the amplitude control block 140 sets a correction value for the end timing t1 that keeps the angular velocity within the allowable angular velocity range.

For example, when the angular velocity rises outside the allowable angular velocity range, that is, when it is equal to or exceeds the upper threshold, the amplitude control block 140 sets a correction value that delays the end timing t1. On the other hand, when the angular velocity is out of the allowable angular velocity range, that is, when it is equal to or less than the lower limit threshold, the amplitude control block 140 sets a correction value that advances the end timing t1.

In accordance with the amplitude correction flow, the control command angle is set in S110 of the angular velocity control flow. That is, as shown in FIG. 12, when a correction value for the end timing t1 is set, in S110, the angle setting block 150 sets a control command angle by linear interpolation for each control period between the start timing t0 and the corrected end timing t1.

Furthermore, in accordance with the amplitude correction flow, in S210 of the distance measurement flow, a determination process is performed using a set amount of change that correlates with the upper limit number of times of light emission per pixel according to the angular velocity. That is, when a correction value for the end timing t1 is set, in S210, the light emission control block 180 determines whether or not the oscillating mirror 32 has been rotated by the set change amount corresponding to the correction value. For example, when a correction value that delays the end timing t1 is set, the light emission control block 180 executes the determination process with a smaller set change amount because the angular velocity of the outward movement becomes slower, which increases the maximum number of times light can be emitted per pixel. Furthermore, when a correction value that advances the end timing t1 is set, the light emission control block 180 executes the determination process with a larger set change amount because the angular velocity of the outward movement increases, thereby reducing the maximum number of light emissions per pixel.

According to the second embodiment, when the angular velocity falls outside the allowable angular velocity range, control is executed to bring the angular velocity within the allowable angular velocity range. Therefore, it is possible to avoid a situation in which the number of times that light can be emitted per pixel decreases due to an excessively large angular velocity, resulting in a decrease in the S/N ratio.

### Third Embodiment

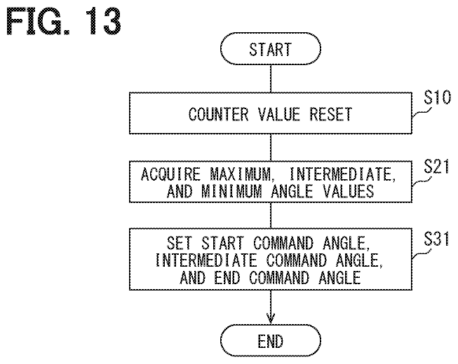

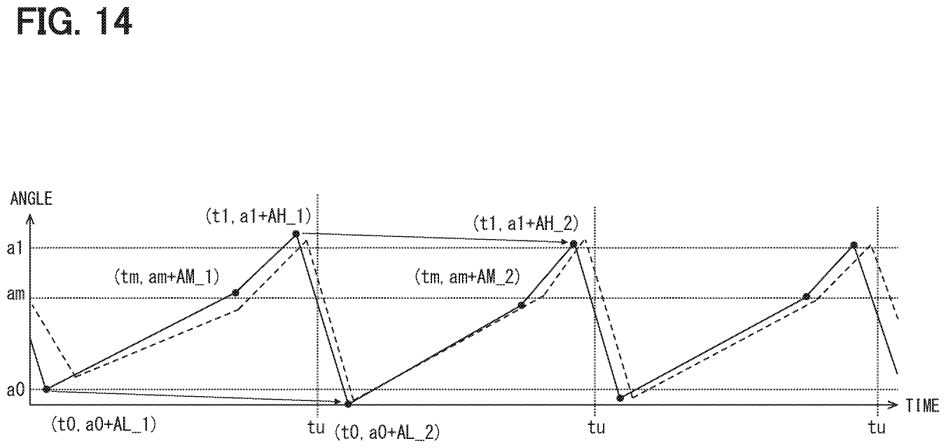

As shown in FIGS. 13 and 14, the third embodiment is a modification of the first embodiment.

In the third embodiment, the amplitude control block 140 controls an intermediate command angle in addition to the start point command angle and the end point command angle. The intermediate command angle is a control command angle at an intermediate timing between the start timing t0 and the end timing t1 in the outward period. As with the start point command angle and the end point command angle, an intermediate target angle is set as a target for the intermediate command angle.

The intermediate target angle is set to impart different linearities to the angular velocity before and after the intermediate timing. In FIG. 14, the intermediate target angle is set so that the angular velocity is greater in a section from the intermediate timing to the end timing t1 than in a section from the start timing t0 to the intermediate timing.

In the third embodiment, in the amplitude correction flow, the processor proceeds to S21 after S10 as shown in FIG. 13. In S21, the amplitude control block 140 acquires the angle detection value at the intermediate timing as an angle intermediate value, which is the actual angle at the intermediate timing. Next, in S31, the amplitude control block 140 corrects and sets an intermediate command angle in addition to the start point command angle and the end point command angle. For example, the amplitude control block 140 may correct the intermediate command angle by feedback control such as PI control, in the same manner as for the start point command angle and the end point command angle.

According to the amplitude correction flow, in S110 of the angular velocity control flow, the control command angle is set with different linearities before and after the intermediate timing. That is, the angle setting block 150 in S110 sets different control command angles by linear interpolation for each control timing between the start timing t0 and the intermediate timing and for each control timing between the intermediate timing and the end timing t1.

Furthermore, in accordance with the amplitude correction flow, in S210 of the distance measurement flow, a determination process is performed using a set amount of change that correlates with the upper limit number of light emissions per pixel according to the angular velocity before and after the intermediate timing. That is, in S210, the light emission control block 180 determines the rotational drive angle of the oscillating mirror 32 with different set change amounts before and after the intermediate timing. In FIG. 14, the light emission control block 180 executes the determination process in the before-intermediate timing with a set change amount that is smaller than that in the after-intermediate timing.

According to the third embodiment, the previous angle deviation is acquired for the intermediate timing tm between the start timing t0 and the end timing t1, and the intermediate command angle at the current intermediate timing is corrected in accordance with the previous angle deviation. Therefore, it is possible to set a different control command angle in advance between the start timing t0 and the end timing t1. Therefore, the degree of freedom in setting the control angle waveform in the oscillation period can be improved.

Furthermore, according to the third embodiment, the angular velocity resulting from variably setting the control command angle for each control timing in the current outward period is given different linearities before and after the intermediate timing. Therefore, it is possible to set sections with different angular velocities before and after the intermediate timing within one outward period. Therefore, more accurate distance measurement may be possible for a part of the scanning area.

### Fourth Embodiment

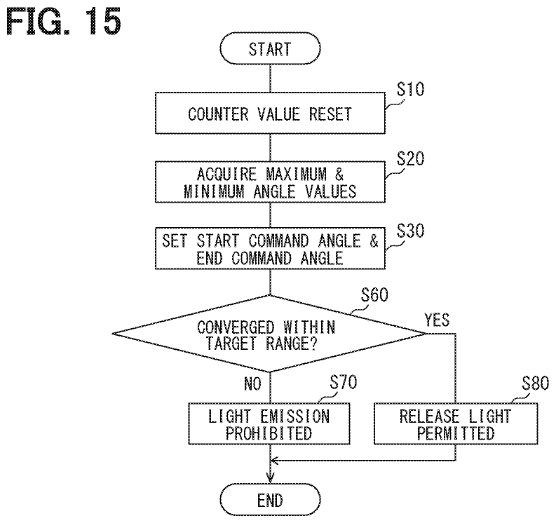

A fourth embodiment is shown in FIGS. 15 to 17 as a modification of the first embodiment.

In the fourth embodiment, in the amplitude correction flow, the processor proceeds to S60 after S30 as shown in FIG. 15. In S60, the angle acquisition block 130 determines whether each of the maximum angle value and the minimum angle value has converged to the target range. For example, the angle acquisition block 130 determines that the angle deviation has converged when the number of consecutive oscillation cycles in which the minimum angle value falls within the target start angle range and the maximum angle value falls within the target end angle range has occurred a specified number of times. The target start point angle range is an angle range that includes the start point target angle. The target end point angle range is an angle range that includes the end point target angle.

When it is determined that the angle deviation has not converged to the target range, the processor proceeds to S70. In S70, the angle acquisition block 130 prohibits the irradiation unit 22 from emitting light. For example, the angle acquisition block 130 sets a light emission prohibition flag in the memory 101 or the like. When it is determined that the maximum angle value and the minimum angle value have converged to their respective target ranges, the processor proceeds to S80. In S80, the angle acquisition block 130 cancels the prohibition of light emission of the irradiation unit 22. For example, the angle acquisition block 130 permits the light emission.

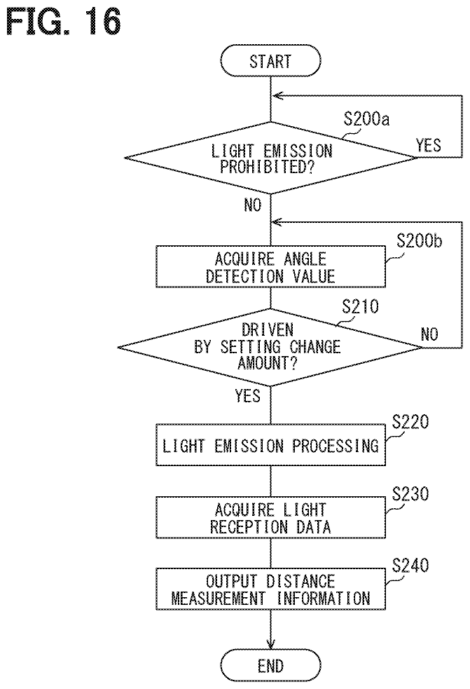

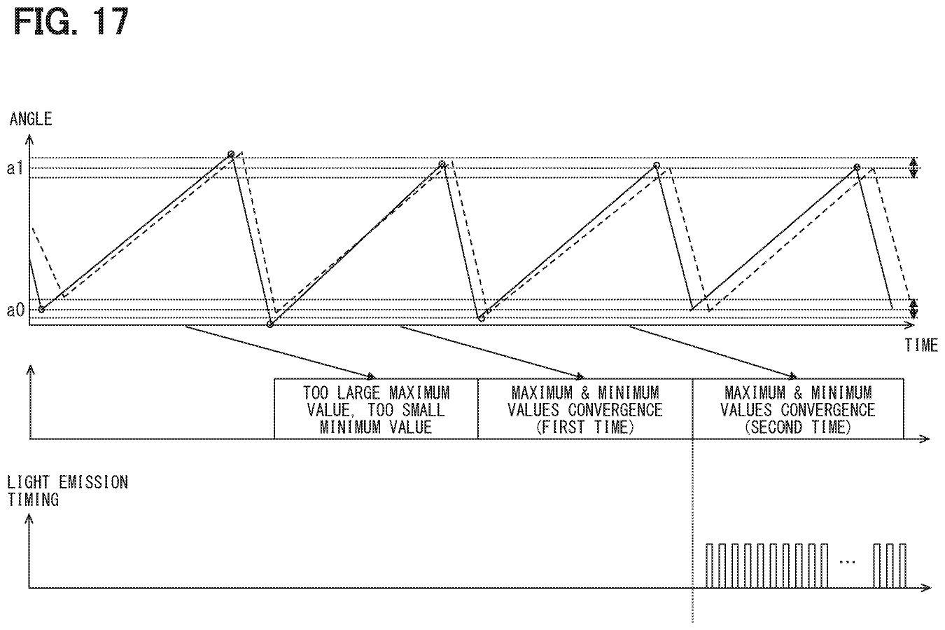

In response to the amplitude correction flow, in the distance measurement flow shown in FIG. 16, a process of determining whether or not light emission is prohibited is carried out before the light emission process. That is, in the distance measurement flow of the fourth embodiment, in S200a, the light emission control block 180 determines whether or not light emission is prohibited. For example, when the light emission prohibition flag is set to ON by accessing the memory 101 or the like, the light emission control block 180 determines that light emission is prohibited. The process of S200a is repeated during the prohibition of light emission. When it is determined that light emission is not prohibited, the processor proceeds to S200b. The process of S200b is the same as the process of S200. By the processes of S60, S70, S80, and S200a, light emission and output of distance measurement information are executed after each of the maximum angle value and the minimum angle value is within the target range, as shown in FIG. 17.

According to the fourth embodiment, the distance measurement is started when the angle deviation converges within the allowable range after startup. Therefore, it is possible to output the distance measurement results after the actual angle at the start timing t0 and the end timing t1 is stabilized.

### Other Embodiments

Although multiple embodiments have been described above, the present disclosure is not to be construed as being restricted to these embodiments, and can be applied to various embodiments and combinations without departing from the spirit of the present disclosure.

In a modification, the control unit 100 may be provided outside the housing 11.

In a modification, the control unit 100 may control the angular velocity non-linearly.

In a modification, the control unit 100 may perform so-called PID control by further adding a differential control to the correction of the control command angle.

In a modification, the control unit 100 may prohibit light emission until the angular velocity converges to the allowable angular velocity range.

In a modification, the dedicated computer of the control unit 100 may be an integrated ECU that integrates driving control of the vehicle 5. The dedicated computer of the control unit 100 may be a determination ECU that determines driving tasks in the driving control of the vehicle 5. The dedicated computer of the control unit 100 may be a monitoring ECU that monitors the driving control of the vehicle 5. The dedicated computer of the control unit 100 may be an evaluation ECU that evaluates the driving control of the vehicle 5.

The dedicated computer of the control unit 100 may be a navigation ECU that navigates a travel route of the vehicle 5. The dedicated computer of the control unit 100 may be a locator ECU that estimates a self-state quantity of the vehicle 5. The dedicated computer of the control unit 100 may be an actuator ECU that controls the travel actuator of the vehicle 5. The dedicated computer of the control unit 100 may be a human machine interface (HMI) control unit (HCU) that controls information presentation in the vehicle 5.

In a modification, the dedicated computer of the control unit 100 may include at least one of a digital circuit and an analog circuit as a processor. The digital circuit refers to at least one type of, for example, an ASIC (Application Specific Integrated Circuit), FPGA (Field Programmable Gate Array), SoC (System on a Chip), PGA (Programmable Gate Array), and CPLD (Complex Programmable Logic Device). The digital circuit may include a memory storing a program.

In a modification, the mobile body to which the control unit 100 is applied may be, for example, an autonomous robot capable of transporting luggage or collecting information by autonomous or remote driving. The embodiments and modifications described above may be implemented as a control unit that is configured to be mountable on a mobile body and has at least one processor 102 and at least one memory 101. Specifically, the above-described embodiment and modifications may be implemented in the form of a processing circuit (e.g., a processing ECU) or a semiconductor device (e.g., a semiconductor chip).

What is claimed is:

1. A light detection device comprising:
an irradiation unit configured to generate and irradiate an irradiation beam by emitting light from a light source;
a scanning unit including an oscillating mirror configured to scan the irradiation beam by oscillating;
a light receiving unit configured to receive a reflected beam; and
a controller including at least one of (i) a circuit and (ii) a processor with a memory, the controller being configured to output a control command of a light emission timing of the light source and a control command angle of the oscillating mirror, wherein
an oscillation period of the oscillating mirror has an outward period during which the irradiation beam is scanned, and a return period,
the controller is configured to:
acquire an actual angle of the oscillating mirror in a previous outward period at each of a start timing and an end timing of the previous outward period;
correct a start point command angle and an end point command angle, each of which being the control command angle of the oscillating mirror at a start timing and an end timing of a current outward period, in response to an angle deviation between the control command angle and the actual angle at the start timing and the end timing of the previous outward period;
control an angular velocity of the oscillating mirror by variably setting the control command angle between the start point command angle and the end point command angle for each control timing between the start timing and the end timing of the current outward period; and
set the light emission timing of the light source for each set change amount of the actual angle in the current outward period.

2. The light detection device according to claim 1, wherein the controller is configured to control the angular velocity by a linear control of the angular velocity.

3. The light detection device according to claim 1, further comprising a biasing member to bias the oscillating mirror in the return period.

4. The light detection device according to claim 1, wherein
the controller is configured to measure a distance to a target object reflecting the irradiation beam, and
the controller is configured to start a distance measurement in response to a converge of the actual angle within an allowable range at the start timing and the end timing.

5. The light detection device according to claim 1, wherein
the controller is configured to control the angular velocity within an allowable range when the angular velocity is out of the allowable range.

6. The light detection device according to claim 1, wherein
the controller is configured to acquire the angle deviation in the previous outward period at an intermediate timing between the start timing and the end timing, and
the controller is configured to correct an intermediate command angle, which is the control command angle at the intermediate timing in the current outward period, in response to the angle deviation in the previous outward period.

7. The light detection device according to claim 6, wherein
the controller is configured to execute a linear control of the angular velocity, by imparting different linearities before and after the intermediate timing to the angular velocity obtained by variably setting the control command angle for each control timing in the current outward period.

8. A light detection method executed by a processor to control a light detection device that detects a reflected beam while an irradiation beam scanned by an oscillating mirror is reflected, comprising:
acquiring an actual angle of the oscillating mirror at a start timing and an end timing of a previous outward period, during which the irradiation beam is scanned, of an oscillation period of the oscillating mirror;
correcting a start point command angle and an end point command angle, each of which being a control command angle of the oscillating mirror at a start timing and an end timing of a current outward period, in response to an angle deviation between the control command angle and the actual angle at the start timing and the end timing of the previous outward period;
controlling an angular velocity of the oscillating mirror by variably setting the control command angle between the start point command angle and the end point command angle for each control timing between the start timing and the end timing of the current outward period; and
setting a light emission timing of a light source that generates the irradiation beam for each set change amount of the actual angle in the current outward period.

9. A non-transitory storage medium storing a light detection program including instructions to be executed by a processor to control a light detection device that detects a reflected beam while an irradiation beam scanned by an oscillating mirror is reflected, the instructions comprising:
acquiring an actual angle of the oscillating mirror at a start timing and an end timing of a previous outward period, during which the irradiation beam is scanned, of an oscillation period of the oscillating mirror;
correcting a start point command angle and an end point command angle, each of which being a control command angle of the oscillating mirror at a start timing and an end timing of a current outward period, in response to an angle deviation between the control command angle and the actual angle at the start timing and the end timing of the previous outward period;
controlling an angular velocity of the oscillating mirror by variably setting the control command angle between the start point command angle and the end point command angle for each control timing between the start timing and the end timing of the current outward period; and
setting a light emission timing of a light source that generates the irradiation beam for each set change amount of the actual angle in the current outward period.
